(19) United States
(12) Patent Application Publication
(10) Pub. No.: US 2026/0192718 A1
(43) Pub. Date: Jul. 9, 2026

(54) Adjustable Automobile Seat

(71) Applicant: Weihua Wang, Jinan (CN)

(72) Inventor: Weihua Wang, Jinan (CN)

(21) Appl. No.: 19/010,114

(22) Filed: Jan. 5, 2025

(51) Int. Cl. B60N 2/30; B60N 2/90

(52) U.S. Cl. CPC B60N 2/3011; B60N 2/933

(57) ABSTRACT

I invented a new type of adjustable automobile seat: it includes a support seat, a cushion frame, a backrest frame, a flip mechanism, a return torsion spring, an unlocking mechanism, and a limit locking part; The support seat is connected, and the backrest frame is connected to the support seat through a reversing mechanism. This seat controls the engagement and opening of the gear plate, limit lock, etc. through the unlocking mechanism to realize the seat adjustment and flip functions.

### TECHNICAL FIELD

The invention relates to the technical field of automobile seats, and specifically refers to new adjustable automobile seat.

### TECHNOLOGY BACKGROUND

With the vigorous development of the automobile industry in China, cars have entered thousands of households. At the same time, with the improvement of people's living standards, the relationship between cars and people is getting closer and closer, and people spend more and more time in cars when living, working, and traveling for leisure. People's demand for automobile is no longer a simple means of transportation, but has put forward more personalized demands for cars. For example, high-quality speakers, DVD displays, etc. are installed in the automobile to increase entertainment. Built-in refrigerator to improve quality of life and more.

The automobile body is the component in the automobile that has the closest contact with the human body. If the functions of the automobile body can be more diversified, it can greatly enrich people's lives. However, the personalized functions of automobile bodies currently on the market are relatively mediocre and lacking, most people can only achieve simple functions such as left and right sliding, backrest angle adjustment, etc., which obviously cannot meet people's habits.

At present, ordinary folding and flipping seats are inconvenient to fold and open. When actually using the folding and flipping seats on the market, you need to fold the backrest by hand until it is flush with the seat cushion, and then operate it under the seat. By opening the unlocking handle mechanism at the bottom of the seat can the seat cushion and backrest be flipped to the upright position. The operation process requires manual operation, which is inconvenient to use; Secondly, since the seats need to be folded and unlocked manually, in order to facilitate the unlocking operation, the flip-up seats are often limited to being arranged close to the middle door, which has an impact on the space layout of the entire vehicle; thirdly, it affects the convenience of rear passengers getting in and out of the vehicle and safety in emergencies. Due to the complicated operation of manually unlocking the seat, the occupant usually does not adjust the seat to the folded position after leaving the passenger seat, which hinders the occupants from getting up. The exit passage requires manual operation to fold when an emergency occurs in the automobile. It cannot quickly provide an escape route for the rear seat occupants. It has poor safety performance and cannot meet the requirements of safety regulations. Fourthly, the current seat mechanism is After the backrest is folded, there is an infinite locking mechanism, and the backrest and seat cushion are in a free state in the folded position. During the driving of the automobile, the backrest and seat cushion often become loose and make abnormal noises.

Therefore, we propose a new type of adjustable automobile seat is proposed to solve the current shortcomings.

### CONTENTS OF THE INVENTION

The technical problem to be solved by the present invention is to overcome the defects of the above technology and provide a new type of adjustable automobile seat.

In order to solve the above technical problems, the technical solution provided by the present invention is a new type of adjustable automobile seat: including a support seat, a cushion frame and a backrest frame;

The cushion frame is rotatably installed in the support seat, and a limiting portion is provided at one side of the connection between the support seat and the cushion frame;

The cushion frame is connected to the other end of the support seat through a rotating part. The rotating part includes a connecting frame, a torsion spring and a locking part. Both ends of the connecting frame are rotationally connected to the supporting seat and the cushion frame respectively. The support The chair seat is located on the outside of the connecting frame and is provided with a fixed frame. The fixed frame is provided with a torsion spring connected to the connecting frame. The connecting frame is provided with a linkage mechanism that cooperates with the fixed frame;

The locking part includes a mounting frame, a locking piece and a connecting shaft. The bottom of the cushion frame is provided with a limiting column 1 and a limiting column 2. The mounting frame is arranged inside the support seat, and the mounting frame is in contact with the support seat. There is a locking piece that cooperates with the limiting column 1 and the limiting column 2. The connecting shaft is rotationally connected to the support seat. The connecting shaft is Both ends are provided with swinging parts that cooperate with the locking parts. The mounting frame is provided with a tension spring 1 that cooperates with the locking parts. One side of the support seat is rotated with a handle connected to the swinging part. The support seat is provided with a tension spring 3 that cooperates with the handle. The inside of the fixed frame is provided with a locking gear that cooperates with the handle. The connecting frame is provided with a toothed plate that cooperates with the locking gear.

As an improvement, the limiting part includes a limiting piece and a limiting rod, the cushion frame is rotationally connected to the support seat through a connecting shaft, a limiting piece is provided on the connecting shaft on one side, and the supporting seat is rotated There is a limit rod that cooperates with the limit member, and the support seat is provided with a tension spring 1 that cooperates with the limit rod.

As an improvement, the fixed frame is provided with a fixed shaft that passes through the connecting frame and is connected to the supporting seat, and the fixed shaft is provided with a torsion spring connected to the connecting frame.

As an improvement, the linkage mechanism includes a connecting rod 1 and a connecting rod 2 that is rotationally connected to the connecting rod 1. The connecting rod 1 is rotationally connected to the connecting frame, and the connecting rod 2 is movably matched with the fixed frame.

As an improvement, the locking piece is provided with a locking groove 1 and a locking groove 2 that cooperate with the limiting column 1 and the limiting column 2 respectively.

The advantages of the present invention compared with the prior art are that:
1, By support seat, cushion frame and backrest frame as the main body, with the rotating part and the limiting part, the cushion frame realizes the angle adjustment and flip operation with the supporting seat through the rotating part, and the cushion frame realizes the connection with the supporting seat through the limiting part. The flipping operation between the support seats can form a transformation between a seat structure and a flatbed structure;
2, Through the settings of the connecting frame, linkage mechanism and torsion spring, the flipping and angle adjustment operations of the cushion frame are realized. At the same time, the setting of the torsion spring facilitates the reset operation of the cushion frame, and the cooperation of the locking part ensures its flipping position. Fixing with angle adjustment position;
3, The overall structure of the seat is simple and easy to operate. It can adjust the angle of the seat cushion frame. At the same time, by cooperating with the cushion frame, the cushion frame and the cushion frame can form a recliner structure, realizing the multi-functional use of the seat. Has strong usage and promotion value.

### DESCRIPTION OF THE FIGURE

FIG. 1 is a schematic structural FIG. 1 of new adjustable automobile seat according to the present invention.

FIG. 2 is a partial enlarged view of point A in FIG. 1.

FIG. 3 is a schematic structural FIG. 2 of new adjustable automobile seat according to the present invention.

FIG. 4 is a side view of a new type of adjustable automobile seat according to the present invention.

FIG. 5 is a partial exploded view 1 of new adjustable automobile seat according to the present invention.

FIG. 6 is a partial enlarged view of B in FIG. 5.

FIG. 7 is a partial enlarged view of C in FIG. 5.

FIG. 8 is a partial enlarged view of D in FIG. 5.

FIG. 9 is a partial exploded view 2 of a new type of adjustable automobile seat according to the present invention.

FIG. 10 is a partial enlarged view of D in FIG. 9.

As shown in the Figure: 1. Support seat, 2. Cushion frame, 3. Backrest frame, 4. Connecting frame, 5. Torsion spring, 6. Fixing frame, 7. Installation frame, 8. Locking piece, 9. Connecting shaft, 10. Limit Position post 1, 11, limit post 2, 12, swing member, 13, tension spring 1, 14, hand Handle, 15. Tension spring 3, 16. Locking gear, 17. Gear plate, 18. Limiting piece, 19. Limiting rod, 20. Connecting shaft, 21. Tension spring 1, 22. Fixed shaft, 23. Connecting Rod 1, 24, connecting rod 2, 25, locking groove 1, 26, locking groove 2.

### DETAILED IMPLEMENTATION

In order to make the purpose, technical solutions and advantages of the embodiments of the invention clearer, the technical solutions in the embodiments of the invention will be clearly and completely described below in conjunction with the drawings in the embodiments of the invention. Obviously, the described embodiments are Some embodiments, not all embodiments. The components of the inventive embodiments generally described and illustrated in the figures herein may be arranged and designed in a variety of different configurations.

In the description of the embodiments of the invention, it should be noted that if the terms “center”, “upper”, “lower”, “left”, “right”, “vertical”, “horizontal”, “inside”, “The orientation or positional relationship indicated by “outside” is based on the orientation or positional relationship shown in the attached drawing, or it is the orientation or positional relationship in which the invention product is usually placed when in use. It is only for the convenience of describing the invention and simplifying the description. It does not indicate or imply that the device or component referred to must have a specific orientation, be constructed and operated in a specific orientation. Therefore, it cannot be construed as a limitation on the invention. In addition, the terms “first”, “second”, “third”, etc. are only used to distinguish descriptions and shall not be understood as indicating or implying relative importance.

In addition, the presence of the terms “horizontal”, “vertical”, “overhanging”, etc. does not mean that the component is required to be absolutely horizontal or overhanging, but may be slightly tilted. For example, “horizontal” only means that its direction is more horizontal than “vertical”. It does not mean that the structure must be completely horizontal, but can be slightly tilted.

In the description of the embodiments of the invention, “plurality” represents at least 2.

In the description of the embodiments of the invention, it should also be noted that unless otherwise explicitly stated and limited, if the terms “setting”, “installation”, “connection” and “connection” appear, they should be understood in a broad sense. For example, it can be A fixed connection can also be a detachable connection or an integral connection; it can be a mechanical connection or an electrical connection; it can be a direct connection or an indirect connection through an intermediate medium; it can be an internal connection between two components. For those of ordinary skill in the art, the specific meanings of the above terms in the invention can be understood according to the specific circumstances.

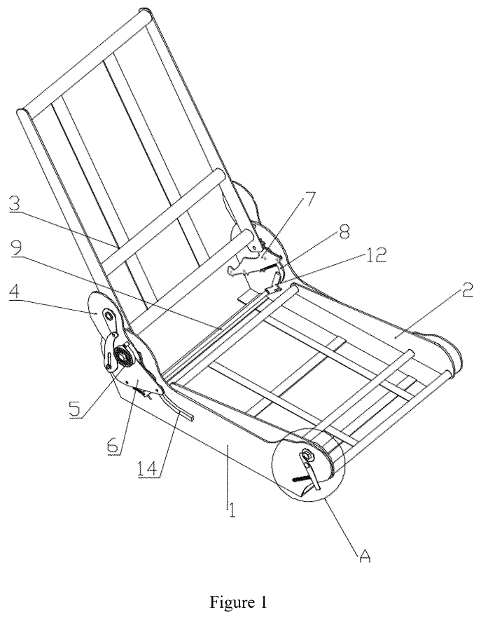

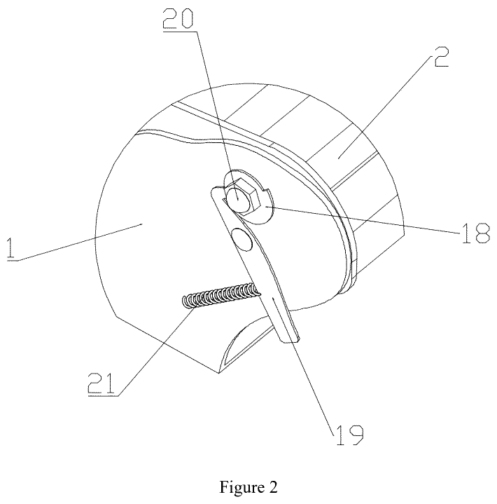

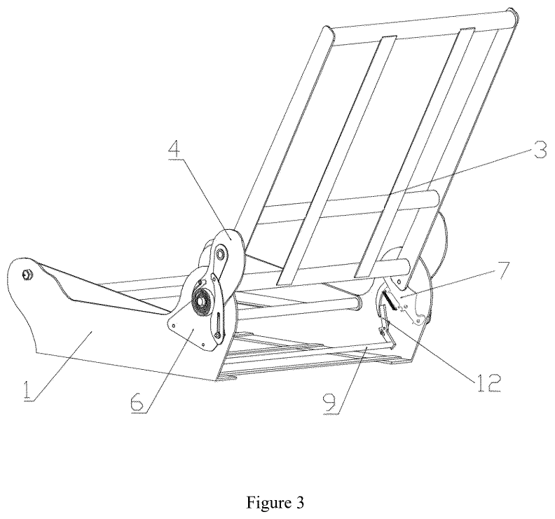

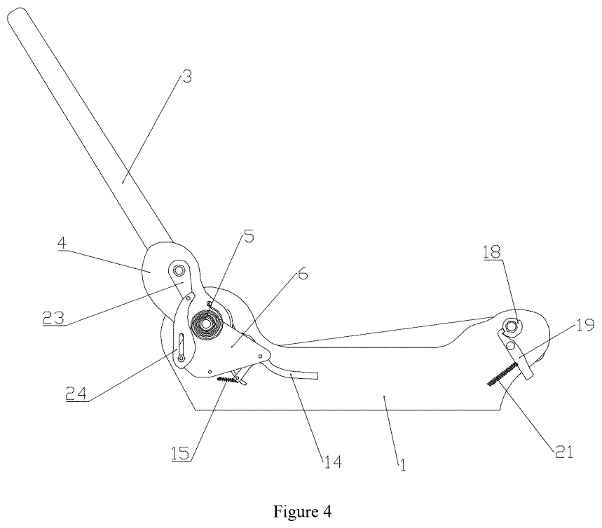

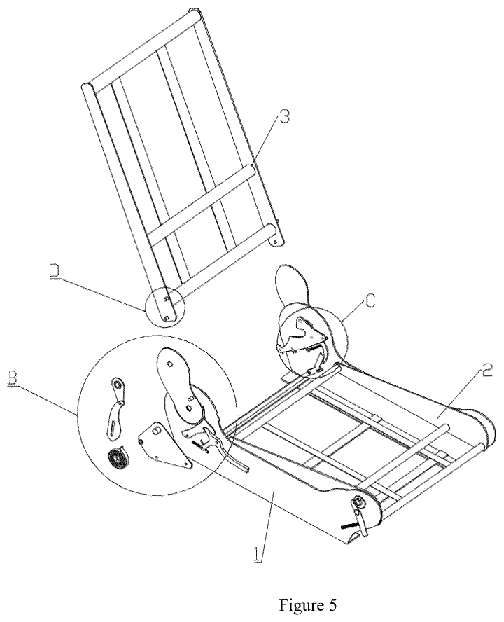

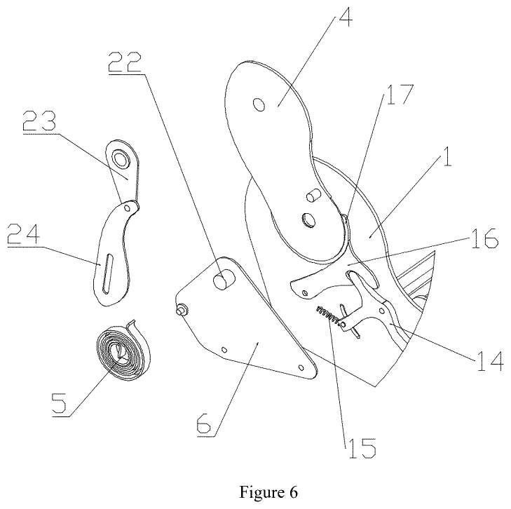

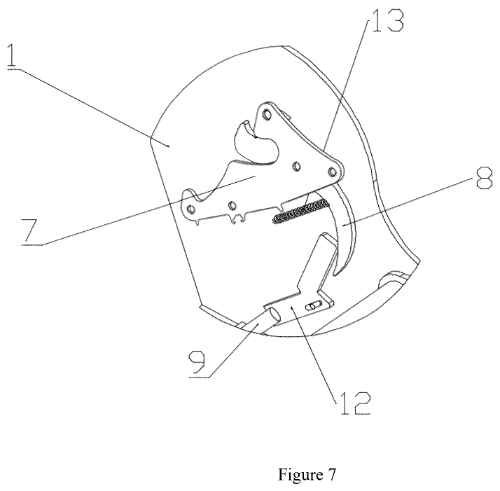

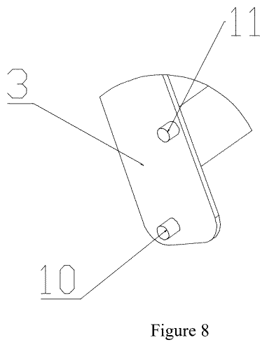

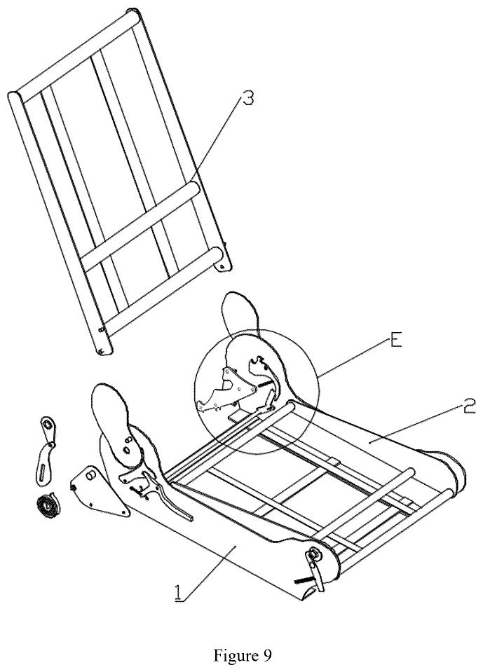

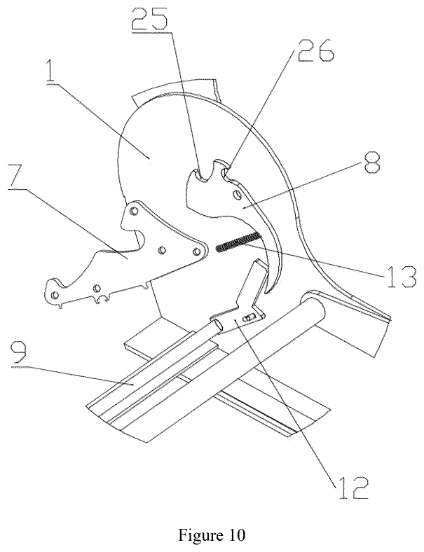

As shown in FIG. 1-10, a new type of adjustable automobile seat forms a transformation between seat structure and flatbed structure.

The seat includes a support seat 1, a cushion frame 2 and a backrest frame 3. Specifically, the support seat 1, the cushion frame 2 and the cushion frame 3 are all frame structures. In actual use, the support seat 1. The cushion frame 2 and the cushion frame 3 can be wrapped with flexible materials to improve their comfort.

The cushion frame 2 is rotatably installed in the support seat 1. A limiter is provided at one side of the connection between the support seat 1 and the cushion frame 2. In specific use, the cushion frame 2 can be placed on the support seat. 1, forming the cushion part of the seat, and at the same time, due to the The cushion frame 2 is rotatably connected to the support seat 1. The cushion frame 2 can be flipped to the front of the support seat 1, and through the setting of the limiter, the cushion frame 2 can be positioned within the support seat 1. Or flip it to the limit position where the front part of the seat 1 is supported.

Specifically, the limiting part includes a limiting piece 18 and a limiting rod 19. The cushion frame 2 is rotationally connected to the support seat 1 through a connecting shaft 20. Specifically, when the cushion frame 2 rotates, the connecting shaft 20 Follow the rotation of the cushion frame 2 to rotate, and the connecting shaft 2 on one side 0 is provided with a limiter 18. Specifically, the limiter 18 is fixedly provided on the connecting shaft 20. In this embodiment, the limiter 18 has a circular structure and is located on the support of the cushion frame 2. When the chair seat 1 is inside, the upper part of the limiter 18 is provided with a semi-annular gap;

The support seat 1 is provided with a limit rod 19 that rotates and cooperates with the limit member 18. Specifically, when the cushion frame 2 is located in the support seat 1, the upper end of the limit rod 19 is in contact with the limit member 18. The upper half-circular notch is snap-fitted on one side;

The support seat 1 is provided with tension springs 1 21 that cooperate with the limit rod 19 to ensure the cooperation between the limit rod 19 and the limit member 18;

In actual use, when the cushion frame 2 is located in the supporting seat 1, the semi-annular notch is located on the upper part of the limiting member 18. At this time, the upper end of the limiting rod 19 is in line with the semi-annular notch on the upper part of the limiting member 18. Side snap connection ensures 2 positions for the cushion frame In order to support the stability within the chair base 1, when it is necessary to flip the cushion frame 2, pull the limit rod 19 to separate it from the limit member 18, and then flip the cushion frame 2 to support the front of the support seat 1 and maintain it in a horizontal state. When you release the limit lever 19, and tighten the tension spring 1 21, the limiting rod 19 is brought into contact with the other side of the semi-annular notch on the limiting piece 18.

The backrest frame 3 is connected to the other end of the support seat 1 through a rotating part. In actual use, through the setting of the rotating part, the angle between the backrest frame 3 and the supporting seat 1 can be adjusted, and at the same time, the seat backrest frame 3 can be flipped forward, and the cushion frame 2 cooperates to form a flatbed structure.

The rotating part includes a connecting frame 4, a torsion spring 5 and a locking part. Both ends of the connecting frame 4 are rotationally connected to the support seat 1 and the backrest frame 3 respectively. The connecting frame 4 is connected to the supporting seat 1 and the cushion frame 3 through the connecting frame 4. The rotational connection can realize the movable connection of the backrest frame 3 in the support seat 1, the adjustment of the angle between the backrest frame 3 and the support seat 1, and the flip operation between the backrest frame 3 and the support seat 1.

The support seat 1 is provided with a fixed frame 6 on the outside of the connecting frame 4. The fixed frame 6 is provided with a torsion spring 5 connected to the connecting frame 4;

Furthermore, the fixed frame 6 is provided with a fixed shaft 22 that passes through the connecting frame 4 and is connected to the support seat 1. The fixed shaft 22 is provided with a torsion spring 5 connected to the connecting frame 4.

During implementation, the fixed frame 6 realizes supporting and fixing functions, the fixed shaft 22 realizes the rotational connection between the connecting frame 4 and the supporting seat 1, and at the same time, the torsion spring 5 is between the backrest frame 3 and the supporting seat 1. When the two are in a vertical state, they are in a natural state. Through the setting of the torsion spring 5, the backrest frame 3 can be reset.

The connecting frame 4 is provided with a linkage mechanism that cooperates with the fixed frame 6. Specifically, the linkage mechanism includes connecting rods 1 to 23 and connecting rods 2 to 24 that are rotationally connected to the connecting rod 23. The connecting rod 1 23 is rotatably connected to the connecting frame 4, and the connecting rods 2 to 24 are movably matched with the fixed frame 6. In this embodiment, the lower part of the connecting rods 2 to 24 is provided with a long slot, which can realize the connecting rod 2 The movable cooperation between 24 and the fixed frame 6 can ensure the rotational stability between the connecting frame 4 and the supporting seat 1 through the setting of the link mechanism.

The locking part includes a mounting frame 7, a locking piece 8 and a connecting shaft 9. The bottom of the cushion frame 3 is provided with a limiting column 10 and a limiting column 2 11. The mounting frame 7 is arranged inside the support seat 1. A locking piece 8 that cooperates with the limiting column 10 and the limiting column 2 11 is rotated between the mounting frame 7 and the supporting seat 1. Specifically, the locking piece 8 is provided with a limiting member 8 respectively. Column one 10 and limiting column two 11 match the locking groove 1 25 and locking slot 2 26.

Specifically, when the backrest frame 3 and the support seat 1 are installed at an angle, the limiting posts 1 10 cooperate with the locking groove 25 in the locking member 8. When the backrest frame 3 cooperates with the seat cushion frame 2 And when it is in a horizontal state, the second limiting column 11 cooperates with the second locking groove 26 in the locking member 8.

The mounting frame 7 is provided with a tension spring 13 that cooperates with the locking piece 8. The tension spring 13 realizes the traction of the locking piece 8 and ensures that the locking piece 8 and the mounting frame 7 cooperate to achieve the limit. The limiting column prevents the limiting column from being separated from the locking member 8.

The connecting shaft 9 is rotationally connected to the support seat 1. Both ends of the connecting shaft 9 are provided with swing parts 12 that cooperate with the locking parts 8. The swing parts 12 are fixedly connected to the connecting shaft 9. Through the connecting shaft 9 The rotation drives the swing member 12 to rotate;

The support seat 1 is provided with a handle 14 connected to the swing member 12 on one side of the rotation. The rear end of the handle 14 is connected to the corresponding swing member 12 through a pin body. At the same time, the support seat 1 is provided with a pin supply body. When the handle 14 is pulled through the moving arc-shaped hole slot, the swing member 12 can rotate through the movement of the pin body. move, and then realize the driving of the connecting shaft 9, thereby realizing the movement of the swinging parts 12 at both ends of the connecting shaft 9. At the same time, because the swinging part 12 cooperates with the locking part 8, when the swinging part 12 rotates, the locking part 8 can be driven by rotating, the locking member 8 is separated from the limiting column, and the backrest frame 3 can be turned over.

The inner side of the fixed frame 6 is provided with a locking gear 16 that cooperates with the handle 14. The connecting frame 4 is provided with a gear plate 17 that cooperates with the locking gear 16. Specifically, the locking gear 16 and the gear plate 17 Engagement to achieve fixation of the relative position between the backrest frame 3 and the support seat 1;

The support seat 1 is provided with a tension spring 3 15 that cooperates with the handle 14. The tension spring 3 15 realizes the traction of the handle 14, ensuring the cooperation between the handle 14 and the locking gear 16, thereby ensuring that the locking gear 16 is in contact with the locking gear 16. The cooperation between the toothed discs 17.

In specific implementation, when the limiting column 1 10 cooperates with the locking groove 25 in the locking member 8, the cooperation between the locking member 8 and the mounting bracket 7 ensures that the limiting column 1 10 limit, at this time, the backrest frame 3 and the support seat 1 are installed at an angle. When the angle adjustment is required, the handle 14 is pulled and the locking gear 16 is separated from the gear plate 17. This way When the angle is adjusted, the cushion frame 3 can be pushed to adjust the angle. After adjusting to a suitable angle, release the handle 14. The handle 14 is on the tension spring 3. Under the action of 15, the locking gear 16 and the toothed disc 17 are driven to cooperate to realize the locking of the toothed disc 17, thereby completing the angle adjustment between the backrest frame 3 and the supporting seat 1;

It should be noted that when adjusting the angle of the backrest frame 3, when the handle 14 is pulled to separate the locking gear 16 and the gear plate 17, the locking member 8 and the limiting column 1 10 remain in a mating state.

When it is necessary to flip the backrest frame 3 forward, pull the handle 14 and drive the locking gear 16 and the gear plate 17 to separate, and at the same time realize the separation between the locking piece 8 and the limiting posts 1 to 10, and then flip the backrest frame 3 forward, and make it in a horizontal state. At this time, the limiting column 2 11 cooperates with the locking groove 2 26 in the locking member 8, and then releases the handle 14. The handle 14 is in the tension spring 3 15, the locking gear 16 and the gear plate 17 are driven to cooperate to lock the gear plate 17. At the same time, the locking groove 2 26 and the mounting bracket 7 cooperate to realize the locking of the limiting column 2 11. Fixed, at this time, the backrest frame 3 remains in a horizontal position.

By supporting the seat, cushion frame and cushion frame as the main body, with the rotating part and the limiting part, the cushion frame realizes the angle adjustment and flip operation with the supporting seat through the rotating part, and the cushion frame realizes the connecting with the supporting chair through the limiting part. The flipping operation between seats can form a transformation between a seat structure and a flat bed structure;

Through the settings of the connecting frame, linkage mechanism and torsion spring, the flipping and angle adjustment operations of the cushion frame are realized. At the same time, the setting of the torsion spring facilitates the reset operation of the cushion frame, and the cooperation of the locking part ensures the flipping position and angle. Fixing of adjustment position;

The overall structure is simple and easy to operate, and can realize the angle adjustment of the seat cushion frame. At the same time, by cooperating with the cushion frame, the cushion frame and the cushion frame can form a seat structure, realizing the multi-functional use of the seat, and is extremely cost-effective. Strong usage and promotion value.

The present invention and its embodiments have been described in a restrictive manner above. This description is not exclusive. What is shown in the drawings is only one embodiment of the invention, and the actual structure is not limited thereto. All in all, if a person of ordinary skill in the art is enlightened and can design structural methods and embodiments similar to the technical solution without deviating from the true nature of the invention, they shall all fall within the protection scope of the invention.

1. adjustable automobile seat, characterized by: including a support seat (1), a cushion frame (2) and a cushion frame (3);
The cushion frame (2) is rotatably installed in the support seat (1), and a limiter is provided at the connection between the support seat (1) and the cushion frame (2) on one side;
The cushion frame (3) is connected to the other end of the support seat (1) through a rotating part. The rotating part includes a connecting frame (4), a torsion spring (5) and a locking part. The two ends of the connecting frame (4) The ends are rotatably connected to the support seat (1) and cushion frame (3) respectively. Then, the support seat (1) is provided with a fixed frame (6) on the outside of the connecting frame (4), and the fixed frame (6) is provided with a torsion spring (5) connected to the connecting frame (4). The connecting frame (4) is provided with a linkage mechanism that cooperates with the fixed frame (6);
The locking part includes a mounting frame (7), a locking piece (8) and a connecting shaft (9). The bottom of the cushion frame (3) provided with limiting column one (10) and limiting column two (11). The mounting frame (7) is arranged inside the support seat (1). The mounting frame (7) is in contact with the support seat (1). There is a locking piece (8) that cooperates with the limiting column one (10) and the limiting column two (10). The connecting shaft (9) is rotatably connected to the support seat (1). The two connecting shafts (9) are the end is provided with a swinging piece that cooperates with the locking piece (8). The mounting frame is provided with two tension springs that cooperate with the locking piece (8). One side of the support seat (1) is rotated with a handle (14) connected to the swinging piece (12). The support seat (1) is provided with tension springs three(15)that cooperate with the handle (14). The inside of the fixed frame (6) is provided with a locking gear (16) that cooperates with the handle (14). The connecting frame (4) is provided with a toothed plate (17) that cooperates with the locking gear (16).

2. adjustable automobile seat according to claim 1, characterized in that: the limiting part includes a limiting piece (18) and a limiting rod (19), and the cushion frame (2) passes through a connecting shaft (20) Ro tally connected to the support seat (1), one side The connecting shaft (20) is provided with a limiter (18), and the support seat (1) is provided with a limiter rod (19) that cooperates with the limiter (18). (1) is provided with a tension spring (21) that cooperates with the limit rod (19).

3. adjustable automobile seat according to claim 1, characterized in that: the fixed frame (6) is provided with a fixed shaft (4) that passes through the connecting frame (4) and is connected to the supporting seat (1). 22), the fixed shaft (22) is provided with a torsion spring (5) connected to the connecting frame (4).

4. adjustable automobile seat according to claim 1, characterized in that the linkage mechanism includes a connecting rod (23) and a connecting rod (24) that is rotationally connected to the connecting rod (23). The first connecting rod (23) is rotatably connected to the connecting frame (4), and the second connecting rod (24) is movably matched with the fixed frame (6).

5. adjustable automobile seat according to claim 1, characterized in that: the locking member (8) is provided with a locking member that cooperates with the first limiting column (10) and the second limiting column (11) respectively. Locking slot one (25) and locking slot two (26).
